(19) United States
(12) Patent Application Publication
(10) Pub. No.: US 2001/0016833 A1
(43) Pub. Date: Aug. 23, 2001

(54) MERCHANT TRANSACTION DATA MINING METHOD

(76) Inventors: DEBORAH EVERLING, NEW YORK, NY (US); GARY ROBOFF, NEW YORK, NY (US)

Correspondence Address: OSTROLENK FABER GERB & SOFFEN, 1180 AVENUS OF THE AMERICAS, NEW YORK, NY, 100368403

(21) Appl. No.: 09/204,390

(22) Filed: Dec. 2, 1998

(51) Int. Cl. G06F 17/60

(52) U.S. Cl. 705/39; 705/38

(57) ABSTRACT

A system and method for obtaining credit card transaction data related to conduct by customers, regardless of the issuer of the actual cards used in the transactions. Transaction data is obtained by an issuer of credit cards from a Merchant Acquirer. The issuer eliminates transactions on cards issued by the issuer and to eliminates duplicate any non-issuer card numbers. A file of “scrubbed” non-issuer credit card numbers is then sent to a Credit Bureau that identifies which of the non-issuer card numbers in the scrubbed file actually belong to consumers who own a card from the issuer. The Credit Union appends the issuer's card number of the consumer to the non-issuer card number and returns this data to the issuer. The issuer is then able to update an internal database which identifies transactions performed by customers of the issuer using cards from a different issuer.

### FIELD OF THE INVENTION

The present invention relates to systems and methods for the analysis of large quantities of credit transactions and more particularly to a system and method for enabling the effective marketing of credit card services to existing customers.

### BACKGROUND OF THE INVENTION

Issuers of debit and credit cards currently perform analysis (“data mining”) of the transactions their customers conduct with respect to the card issued by the issuer. This transactional information is acquired directly by the issuer because of the use of the issuer's card by the customer. The transactional data can include information with respect to where the customer has used the card, how much has been spent on the card, the type of merchants frequently visited and which card services are most often used by the customer.

A significant deficiency in the analysis currently performed by issuers is that the analysis is only performed with respect to transactions occurring on the issuer's own card or cards. In reality, consumers often have several credit and/or debit cards from several issuers. For example, some consumers use a particular credit card for travel because of incentives provided by the issuer of that card, while the same consumer uses a different card for other more general purposes.

In the current systems and methods of analysis used by issuers, the issuer is ignorant with respect to the consumer's usage of these other cards and can therefore not make informed decisions about proper marketing strategies targeted towards its existing customers.

### SUMMARY OF THE INVENTION

The present invention solves the problems of the prior art systems and methods by performing analysis on credit and debit card transactions conducted by its customers, regardless of the issuer of the actual cards used in the transactions. Complete transaction data is obtained by the issuer from a Merchant Acquirer. A Merchant Acquirer is an agent for the bank of a merchant. The Merchant Acquirer participates in the approval of a request for charges by cardholders at the merchant. In this role, the Merchant Acquirer obtains all transaction data with respect to the merchant's bank and thus is able to provide the transaction data to the issuer.

After the transaction data, including credit card numbers, is received by the issuer from the Merchant Acquirer, it is “scrubbed” in order to eliminate transactions on cards issued by the issuer and to eliminate any duplicate non-issuer card numbers. A file of “scrubbed” non-issuer credit card numbers is then sent to a Credit Bureau for processing.

The Credit Bureau maintains credit profiles on holders of credit/debit cards. Using the scrubbed file from the issuer and its own internal credit profiles, the Credit Bureau identifies which of the non-issuer card numbers in the scrubbed file actually belong to consumers who own a card from the issuer. Once this identification has been made, the Credit Bureau appends the issuer's card number of the consumer to the non-issuer card number in the scrubbed file. This update file is then returned to the issuer for analysis. In this manner, the issuer is able to identify which of its card holders carry other credit cards, which cards are used most frequently, where the cards are being used and how the consumers uses the issuer's card with respect to its other credit cards. With this type of information in hand, the issuer can develop marketing plans to target its existing customers in order to induce the customer to use the issuer's card instead of any non-issuer card.

### BRIEF DESCRIPTION OF THE DRAWINGS

For the purpose of illustrating the invention, there is shown in the drawings a form which is presently preferred, it being understood, however, that the invention is not limited to the precise arrangement and instrumentality shown.

FIG. 1 illustrates the conventional approval process when a cardholder requests a charge at a merchant;

FIG. 2 is a high level block diagram illustrating the data flow of the processing of the present invention;

FIG. 3 depicts processing of transaction data performed by the issuer;

FIG. 4 depicts the processing performed by the Credit Bureau; and

FIG. 5 illustrates the updating of the internal database by the issuer.

### DETAILED DESCRIPTION OF THE INVENTION

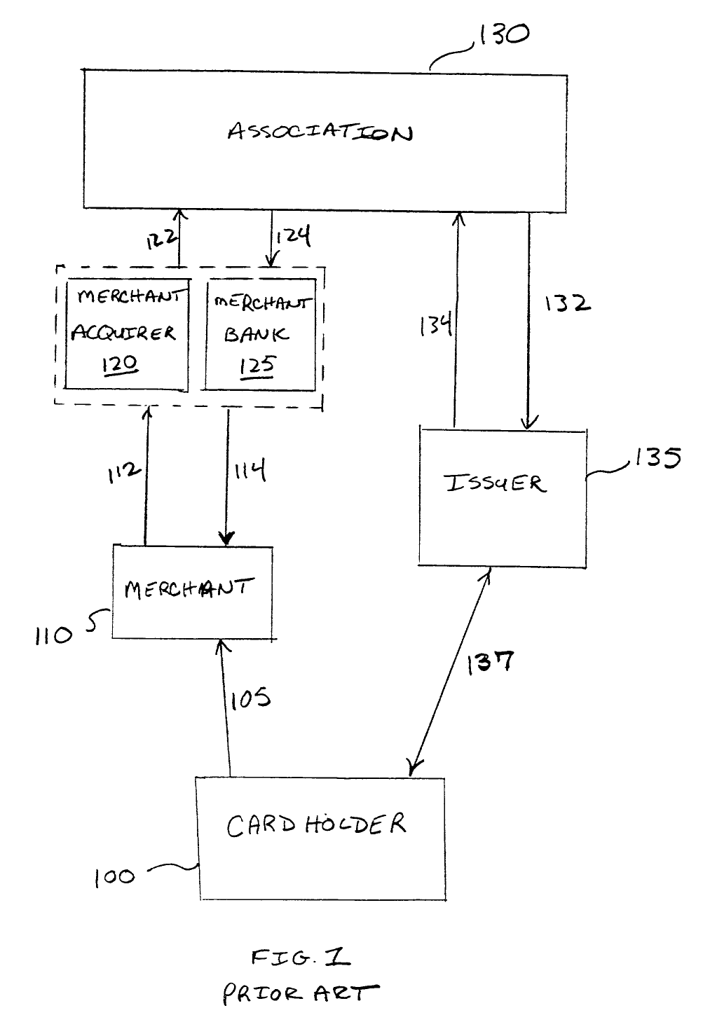

As way of background, FIG. 1 illustrates the approval process when a consumer/cardholder 100 has requested a charge 105 at a merchant 110. When the merchant 100 has received the request for the charge 105, it formats the request 105 and forwards a formatted request for approval 112 to its bank 125. Typically, instead of the bank 125 directly receiving the request for approval 112, its agent, a Merchant Acquirer 120 processes the request 112. The Merchant Acquirer 120 both stores the information constituting the request 112 and forwards the request 122 to an Association 130 such as Visa™ or Mastercard™. The Association 130 then forwards the request 132 to the institution 135 which issued the card to the cardholder 100. The institution 135 is typically a bank, but is not necessarily always so. This institution 135 will be referred to as the Issuer 135 Because the Issuer 135 maintains the cardholder's account, it is able to determine if the request for approval (112, 122, 132) should be granted or denied. The decision 134, whether granting or denying approval, is forwarded back to the Association 130, forwarded 124 to the Merchant Acquirer 120 and returned 114 to the merchant 110. The flow 137 between the cardholder 100 and the Issuer 135 represents the settlement process (i.e., paying the bill).

As described above, the Merchant Acquirer 120 in its processing of the request 112 retains data describing the transaction. In this role, a typical Merchant Acquirer 120, on a monthly basis, obtains transaction data with respect to millions of transactions related to millions of cardholders 100 issued by thousands of Issuers 135. Prior to the present invention, the Issuer 135 never made use of the transaction data acquired the Merchant Acquirer 120.

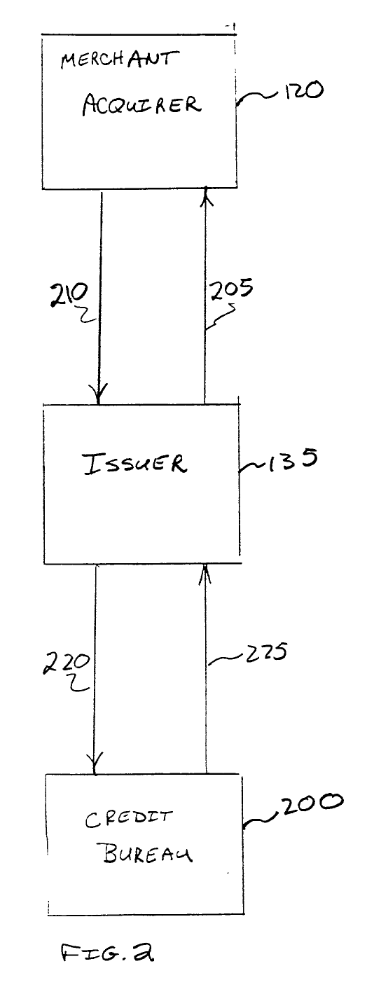

FIG. 2 illustrates, at a high level, the data flow of the present invention. On a regular basis, for example monthly, the Issuer 135 requests 205 “raw” transaction data from the Merchant Acquirer 120. The term “raw” in this context means that the transaction data has not yet been processed by the Issuer 135. The request 205 can also be a standing request (i.e., the Merchant Acquirer 120 sends the transaction data to the Issuer 135 even without having received a specific request 205). In response to the request 205, the Merchant Acquirer 120 forwards 210 “raw” transaction data to the Issuer 135. A sample of the types of information contained in the “raw” transaction data is described below in connection with Table 1.

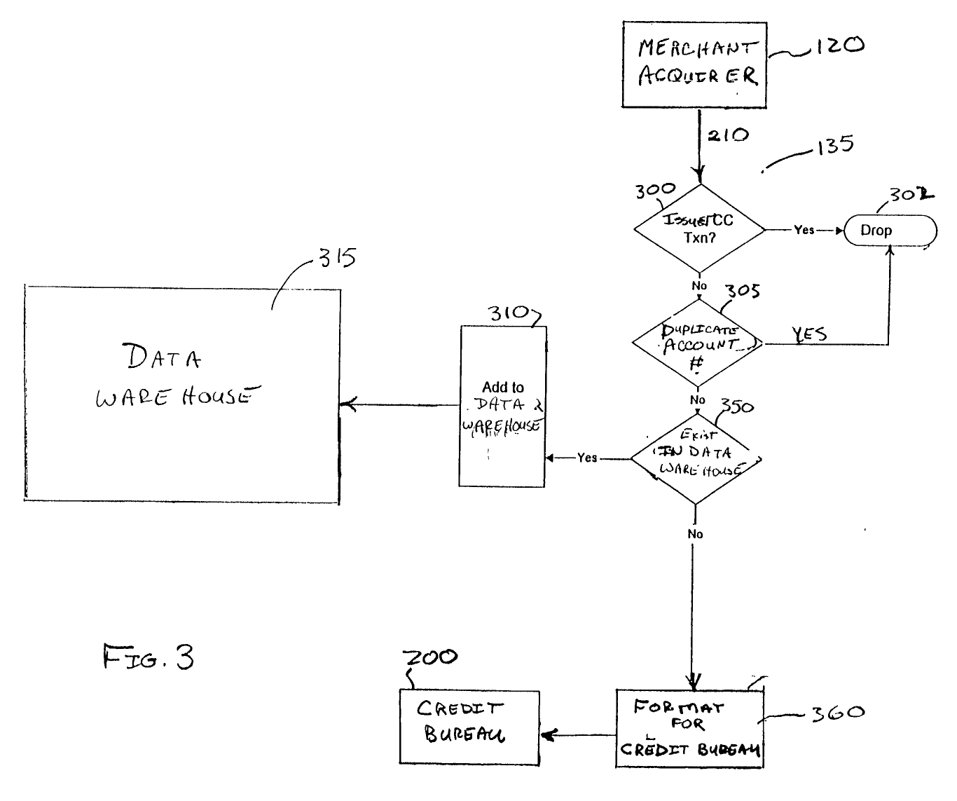

Upon receipt of the raw transaction data, the Issuer 135 performs a “scrubbing” process on the data as more fully described below with respect to FIG. 3. The scrubbing process eliminates duplicate transactions and stores new transactions related to non-Issuer accounts which may be owned by existing Issuer cardholders. As a result of the scrubbing process, a file is produced which contains transaction records for non-Issuer accounts about which the Issuer 135 has no knowledge whatsoever. In order to identify if any of the transactions were made on non-Issuer cards which belong to an existing customer of the Issuer 135, the scrubbed file is transmitted 220 to a Credit Bureau 200. In order to minimize the processing performed by the Credit Bureau 200, the scrubbed file can consist of merely a listing of the non-Issuer account numbers.

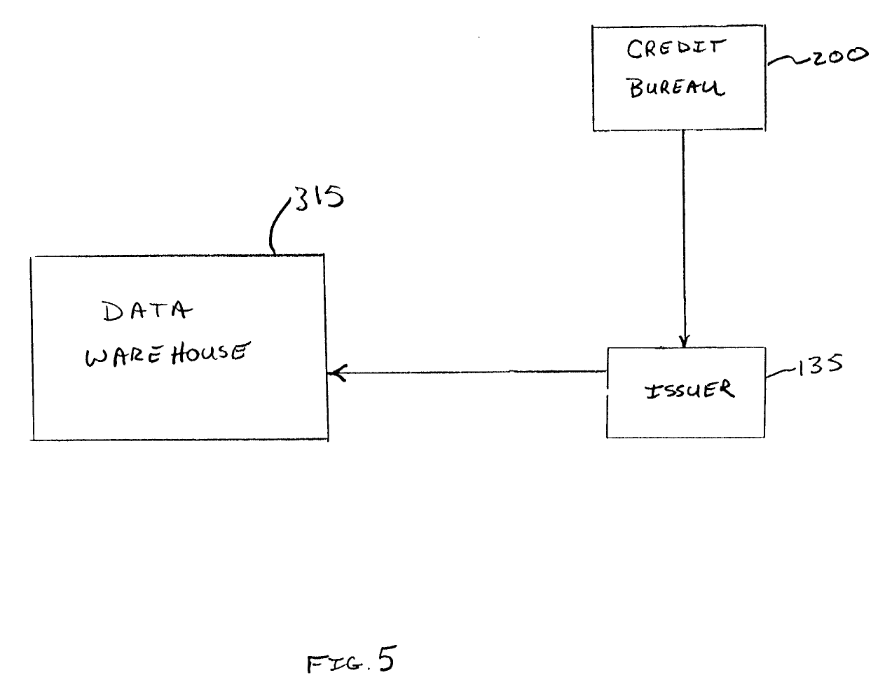

The Credit Bureau 200 maintains credit files for each of the existing customers of the Issuer 135. As part of these credit files, the Credit Bureau 200 has a record of the account numbers of all of the cards carried by the customer. The Credit Bureau 200 performs a matching operation in which it identifies transactions having account numbers which belong to customers of the Issuer 135, regardless of whether or not the account is an Issuer account. If a match is found, the Credit Bureau 200 will append the Issuer's account number to the transaction record containing the previously unknown account number. The matching process performed by the Credit Bureau 200 is described below in connection with FIG. 5.

Once the Credit Bureau 200 has completed its matching process, it forwards 225 the file containing appended records back to the Issuer 135. With the appended file in hand, the Issuer 135 is able to update its internal database to: 1) link new account numbers to existing Issuer account numbers; and 2) update its transaction database with the transactions performed on the newly identified account numbers.

Table 1 depicts a sample of the type of information (data fields) captured by a Merchant Acquirer 135 with respect to each transaction it processes. Typically, the Merchant Acquirer 135 maintains this information in a database with one record per transaction with each record containing the fields described in Table

TABLE 1

| | |
|---|---|
| 1. | Merchant Name |
| 2. | Merchant Account Number, assigned by |
| | Merchant Acquirer |
| 3. | Merchant City |
| 4. | Merchant State, Province, Country |
| 5. | Merchant Category Code (MCC) |
| 6. | Standard Industry Code (SIC) |
| 7. | Merchant Zip Code |
| 8. | Cardholder Account Number |
| 9. | Transaction Amount |
| 10. | Transaction Date |
| 11. | Card Expiration Date |
| 12. | Cardholder ID |
| 13. | Transaction Code |
| 14. | Product Code |

Fields 1 through 7 are each related to the merchant 110 involved in the transaction while fields 8 through 14 relate more specifically to the cardholder 100. Field 5, Merchant Category Code (MCC) is an industry code which is more refined than the Standard Industry Code (SIC) record 6. The cardholder ID, field 12, indicates whether the signature of the cardholder 100 was verified, a Personal Identification Number (PIN) was entered, or whether it was a mail order transaction. The transaction code, field 13, indicates the type of transaction which occurred (e.g., sale, credit or cash advance). The product code, field 14, indicates the type of card used (e.g., American Express™, Discover™, or a bank card). Additional information relating to certain transactions is also retained by the Merchant Acquirer 135 but will not be further described as this information is not essential to the understanding of the present invention.

The file of raw transaction data 210 forwarded from the Merchant Acquirer 120 to the Issuer 135 can contain some or all of the above described transaction data. Once the raw transaction data 210 has been received by the Issuer 135 from the Merchant Acquirer 120, the Issuer 135 performs a “scrubbing” process on the raw transaction data as illustrated in FIG. 3.

As depicted in FIG. 3, the Issuer 135 receives the raw transaction data file 210 from the Merchant Acquirer 120. The Issuer 135 then, for each transaction record contained in file 210, performs a scrubbing process in order to eliminate duplicate and/or unnecessary records. The first step 300 in the process is to determine whether or not the transaction relates to a card issued by the Issuer 135. If the transaction was performed by a cardholder 100 of the Issuer 135, the record for the transaction is dropped 302. The information relating to this transaction is retained separately during the conventional process of the Issuer 135 maintaining the cardholder's account. Accordingly, only transactions which do not belong to the Issuer 135 should remain.

In step 305, it is determined if non-issuer account numbers appear more than once. If yes, the duplicate account numbers are eliminated in step 302. Once duplicate account numbers have been eliminated, the process moves onto step 350 in which it is determined whether or not the card account number contained in the transaction record already exists in the data warehouse 315. The data warehouse 315 contains, in part, information relating to non-Issuer accounts which have previously been determined to belong to an Issuer's cardholder. The data warehouse 315 further contains all of the database files required to perform the processing of the present invention. Preferably these database files are maintained in a relational database in order to facilitate relatively quick and simple access to the records contained in the database, both for updating the database files and for performing analysis on the data. Again, in step 350 it is determined whether or not the transaction was performed by an Issuer cardholder who has a non-Issuer account identified in the data warehouse 315. If the non-Issuer account number is in the data warehouse 315, the transaction information can be added, at step 310, to the data warehouse 315. The records which survive step 350 reflect card account numbers which have not been previously identified as belonging to customers of the Issuer 135.

The process of scrubbing described above is repeated for every transaction data record received from the Merchant Acquirer. Once the file (or a copy thereof) containing the transactions records have been scrubbed by the above described process, the file is formatted 360 for transmission to the Credit Bureau 200. Typically, the only information required by a Credit Bureau 200 to match non-Issuer account numbers to Issuer account numbers is the non-Issuer account number as described in the matching process below.

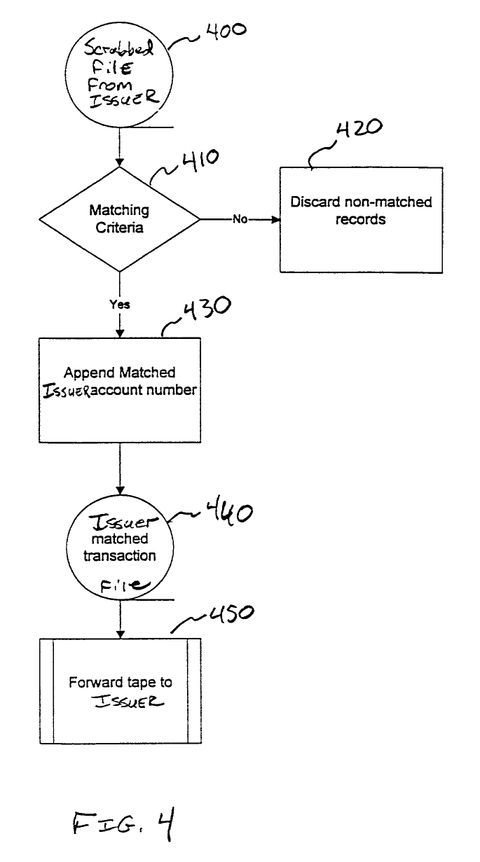

FIG. 4 depicts the matching process performed by the Credit Bureau 200. The formatted file 400 from the Issuer 135 is received by the Credit Bureau 200. In step 410, an account number from the formatted file 400 is compared to the Credit Bureau's list of other account numbers belonging to customers of the Issuer 135. If the account does not belong to any existing customer of the Issuer 135, the record for that account number is thrown away in step 420.

If the account number is determined to belong to an existing customer of the Issuer 135, then the Issuer's account number for the customer is appended to the record for the previously unmatched account number. Steps 410-430 are repeated for every record contained in the scrubbed file 400. Once the matching process 410-430 has been completed, a file 440 containing only the appended records is generated and forwarded 450 back to the Issuer 135.

FIG. 5 illustrates the updating process performed by the Issuer 135 upon receipt of the appended file from the Credit Bureau 200. As described above, the appended file includes at least records containing the account number of the non-Issuer account and the appended Issuer account number. For each of the records in the appended file, the newly identified non-Issuer account number is added to the data warehouse and is linked to the existing Issuer account in data warehouse. Additionally, the actual transaction information associated with the newly identified non-Issuer account number can be added to data warehouse 315.

Once the data warehouse 315 has been updated, the Issuer 135 can then perform any variety of analysis on this data in order to identify specifically targeted marketing opportunities. For example, simple query of the data warehouse 315 would identify all of the existing customers of the Issuer who have used someone else's credit card to rent a car. The Issuer 135 could then design a promotion targeted at these existing customers which would hopefully induce the customer to use its card when renting cars in the future.

Although the present invention has been described in relation to particular embodiments thereof, many other variations and modifications and other uses will become apparent to those skilled in the art. It is preferred, therefore, that the present invention be limited not by the specific disclosure herein, but only the gist and scope of the disclosure.

What is claimed:

1. A method for processing transaction data comprising the steps of:
receiving transaction data, the transaction data containing account numbers;
identifying non-issuer account numbers which represent accounts not issued by an issuer; and
matching the identified non-issuer account numbers with account numbers representing accounts issued by the issuer.

2. A method as recited in claim 1, wherein the matching step comprises:
identifying a consumer associated with at least one of the identified non-issuer account numbers;
determining if the identified consumer is a customer of the issuer, the customer having an issuer account number representing an issuer account issued by the issuer; and
linking the non-issuer account number of the customer with the issuer account number of the customer.

3. A method as recited in claim 1, further comprising the step of maintaining a database containing issuer account numbers representing issuer accounts of customers of an issuer, and containing customer non-issuer account numbers representing non-issuer accounts of the customers.

4. A method as recited in claim 3, further comprising the step of:
adding the matched non-issuer account numbers to the database as customer non-issuer account numbers.

5. A method as recited in claim 3 wherein the database further contains historical transaction data representing previous transactions performed by the customer using a non-issuer account, the method further comprising the step of:
updating the historical transaction data in the database by adding received transaction data which contains matched non-issuer account numbers.

6. A method as recited in claim 3, further comprising the step of performing queries on the database.

7. A method as recited in claim 6, further comprising determining the use of the non-issuer account by the customer in response to a result of the query.

8. A method as recited in claim 7, further comprising marketing services of the issuer to the customer in response to the determined use by the customer.

9. A method as recited in claim 1, further comprising the steps of:
eliminating transaction data containing account numbers issued by the user;
eliminating transaction data which contains data representing duplicate non-issuer account numbers.

10. A method for processing transaction data comprising the steps of:
receiving new transaction data, the new transaction data representing new credit transactions and comprising records containing at least account numbers of accounts which initiated the new credit transactions;
eliminating new transaction data containing issuer account numbers, the issuer account numbers representing issuer accounts of customers of an issuer;
generating a list of account numbers contained in the new transaction data which are not issuer account numbers;
identifying account numbers in the list which represent accounts owned by the customers, the identified account numbers being denoted as non-issuer account numbers; and
associating, by customer, the non-issuer account numbers with issuer account numbers.

11. A method as recited in claim 10, further comprising the step of maintaining a database containing issuer account numbers, and containing customer non-issuer account numbers representing non-issuer accounts of the customers.

12. A method as recited in claim 11, further comprising the step of:
adding the associated non-issuer account numbers to the database as customer non-issuer account numbers.

13. A method as recited in claim 11 wherein the database further contains historical transaction data representing previous credit transactions performed by the customer using a non-issuer account, the method further comprising the step of:
updating the historical transaction data in the database by adding new transaction data which contains the associated non-issuer account numbers.

14. A method as recited in claim 11, further comprising the step of performing queries on the database.

15. A method as recited in claim 14, further comprising determining use of the non-issuer account by the customer in response to a result of the query.

16. A method as recited in claim 15, further comprising marketing services of the issuer to the customer in response to the determined use by the customer.

17. A method as recited in claim 10, further comprising the step of:
eliminating duplicate account numbers.

18. A method for processing transaction data comprising the steps of:
maintaining a database containing issuer account numbers representing issuer accounts of customers of an issuer, containing non-issuer account numbers representing non-issuer accounts of the customers, and containing historical transaction data associated with non-issuer accounts;
receiving new transaction data, the new transaction data representing new credit transactions and comprising records containing at least account numbers of accounts which initiated the new credit transactions;
eliminating new transaction data containing issuer account numbers by comparing the new transaction data to the issuer account numbers maintained in the database;
updating the historical transaction data maintained in the database by adding new transaction data containing non-issuer account numbers;
generating a list of account numbers contained in the new transaction data which are not issuer account numbers and which are not non-issuer account numbers;
eliminating duplicate account numbers from the list;
identifying new non-issuer account numbers contained in the list;
associating the new non-issuer account numbers with issuer account numbers;
adding the new non-issuer account numbers to the database; and
updating the historical transaction data in the database by adding the new transaction data containing the new non-issuer account numbers.

19. A method as recited in claim 18, further comprising the step of performing queries on the database.

20. A method as recited in claim 19, further comprising determining use of the non-issuer account by the customer in response to a result of the query.

21. A method as recited in claim 20, further comprising marketing services of the issuer to the customer in response to the determined use by the customer.
